(19) United States
(12) Patent Application Publication
(10) Pub. No.: US 2020/0056766 A1
(43) Pub. Date: Feb. 20, 2020

(54) LIGHTING SYSTEM FOR SURFACE APPLIQUES AND METHOD OF RETENTION OF CYLINDRICAL OBJECTS

(71) Applicant: HYPERFORM INCORPORATED, ROCKLEDGE, FL (US)

(72) Inventors: Harry Daniel Wheatley, Indialantic, FL (US); Joseph Michael Wood, JR., Melbourne, FL (US); Kurt Wilson, Rockledge, FL (US); Jason Gardner, Melbourne Beach, FL (US)

(73) Assignee: HYPERFORM INCORPORATED, ROCKLEDGE, FL (US)

(21) Appl. No.: 16/541,119

(22) Filed: Aug. 14, 2019

Related U.S. Application Data
(60) Provisional application No. 62/718,953, filed on Aug. 14, 2018.

(51) Int. Cl. F21V 19/00

(52) U.S. Cl. CPC F21V 19/004; F21Y 2115/10; F21V 19/008

(57) ABSTRACT

A structure for retaining an object such as a lighting element, comprising a base structure having at least one surface and a retaining cavity disposed in a surface of the base structure, wherein the retaining cavity cross section comprises opposing tapered window retention surfaces and opposing bevel surfaces disposed between the surface opening and each of the opposing tapered window retention surfaces. A lighting element may be disposed in the retaining cavity. The retaining cavity may have a cross section that is complementary to a cross section of an object to be retained. A lighting system for a base structure comprising a plurality of stacked planar sheets, having a lighting element disposed between a top sheet and the next planar sheet below the top sheet in the stack of sheets, oriented such that a portion of the light emitted by the lighting element passes through said top sheet.

### CROSS REFERENCE TO RELATED APPLICATIONS AND INCORPORATION BY REFERENCE

This application is a non-provisional of U.S. provisional patent application Ser. No. 62/718,953 filed in the United States Patent and Trademark Office (USPTO) on Aug. 14, 2018, titled LIGHTING SYSTEM FOR SURFACE APPLIQUES AND METHOD OF RETENTION OF CYLINDRICAL OBJECTS, which is hereby incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for providing lighting systems for appliques that are applied to surfaces for decorative, cushioning or sound deadening purposes; and the application relates further to structures for retaining cylindrically-shaped objects in a material.

### 2. Background Art

Traction and cushioning pads, herein referred to generally as “pads”, for vehicles and other structures such as, for example, boats, jet skis, kayaks, golf carts, recreational vehicles, pool decks, spas, and other structures are used to provide traction, to provide a soft surfaces upon which to stand or sit, to provide sound deadening and to provide decoration to the surfaces to which they are applied. In certain cases, but not always, such pads are configured as appliques that are attached to a surface of the vehicle or structure by using snaps or by chemical bonding to the surface to which they are applied. In many cases the pad material is a compressible material such as EVA foam or rubber.

Many of the vehicles or structures to which such pads are applied are used or operated at night. Such vehicles or structures may utilize lighting to illuminate the surfaces to which the pads are applied, but such lighting is typically located such that it may cause visibility issues at night by reducing the night vision of a user. It would be advantageous for lighting to be integrated in the pads so as to provide increased visibility, and decoration, to the pads and to the surrounding surfaces, without causing night blindness in the user.

What is needed in the art, therefore, is an apparatus and/or method adapted to integrate lighting into traction and cushioning pads that may be placed, for example on boat, spa, equipment, vehicle, recreational vehicle, towable campers, golf carts, coolers, floors, walls, displays, or other vehicle or equipment surfaces. Since many lighting elements, such as strip lighting elements, are packaged in a cylindrically shaped housing or container, a system and method for capturing such cylindrically shaped strip lights in a traction or cushioning pad applique, which allows for the easy and quick installation of the lighting element into the traction or cushioning pad applique, is needed.

### BRIEF SUMMARY OF THE INVENTION

The present invention comprises an apparatus and method that have one or more of the following features and/or steps, which alone or in any combination may comprise patentable subject matter.

The present invention overcomes the shortcomings of the prior art in that it integrates lighting elements directly in traction and cushioning pad appliques, providing both increased visibility for the user and decoration of the surface to which they are applied. Lighting elements may be assembled into a traction or cushioning pad applique by pressing a lighting element or elements into a retaining cavity that is adapted to receive and retain the lighting element. In a preferred embodiment, the lighting element is retained by a complementary-shaped retaining cavity in the pad. In alternative embodiments, the lighting element may be retained by capturing the lighting element in a press fit in the pad, in which the lighting element is held in place by the compression of pad material around the lighting element in the retaining cavity, creating forces acting on the lighting element as the lighting element is pressed into and compress the pad material around the lighting element or other object to be retained.

The light system and method of retention of cylindrical objects of the invention may be applied to, attached to, or form a part of any boat, kayak, canoe, water sports vehicle, jet ski, pool, spa, equipment, vehicle, recreational vehicle, towable camper, golf cart, cooler, floor, wall, display, or other vehicle, structure or equipment surface. The invention is intended for use on any surface, on any structure. The light system and method of retention of cylindrical objects of the invention may be used to capture and retain lighting elements of any cross sectional shape, although in certain embodiments the cross section of the light-retaining feature of the invention may be shown as capturing light elements of cylindrical or rectangular cross section in the present written description and drawings.

In accordance with one embodiment of the present invention, the invention comprises the embedding of lighting elements directly into the traction and cushioning pads in such a manner that light emanates from the pad itself, without the need for any lighting exterior to the pad.

In an embodiment, the invention comprises a retention apparatus for retaining an object, comprising a base structure that has a surface and a retaining cavity disposed in and running along and below the base structure surface, the retaining cavity comprising an opening into the surface that runs along the retaining cavity for allowing the insertion of an object to be retained in said retaining cavity. In embodiments, the object to be retained may be a lighting element. In cross section, the retaining cavity opening is further defined as having a pair of opposing bevel surfaces where the retaining cavity opening opens into the base structure surface. The retaining cavity opening further comprises a pair of opposing window retention surfaces disposed between the retaining cavity and the pair of opposing bevel surfaces.

In embodiments, the base structure may be fabricated from a sheet or a plurality of sheets of compressible material such as EVA or PE foam.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a perspective view an embodiment of a base structure of the invention.

FIG. 2 depicts a side view of an embodiment of a base structure of the invention, showing a plurality of layers of base structure material, wherein the base structure is attached to a surface such as a boat, pool, spa, kayak, recreational vehicle, golf car, pool, spa or other surface.

FIG. 3 depicts a side view of an embodiment of a base structure of the invention showing the retention apparatus of the invention disposed in a side wall of an exemplary planar base structure, and showing objects to be retained, such as lighting elements, disposed in and retained by the retention apparatus.

FIG. 4 depicts a side view of an embodiment of a base structure of the invention showing the retention apparatus of the invention disposed in a top wall of an exemplary planar base structure, and showing objects to be retained, such as lighting elements, disposed in and retained by the retention apparatus.

FIG. 5 depicts a side view of an embodiment of a base structure of the invention, showing objects to be retained, such as lighting elements, disposed between material of layers of the base structure.

FIG. 6 depicts a top view of an embodiment of the inventive retention apparatus of the invention, in which the retention apparatus is located in a top surface of a base structure.

FIG. 7 depicts a side cross section view of an embodiment of the inventive retention apparatus of the invention, in which the retention apparatus is located is a top surface of a base structure.

FIG. 8 depicts a side cross section view of an embodiment of the inventive retention apparatus of the invention, in which the retention feature is located in a side surface of a base structure.

FIG. 9 depicts a side view of an embodiment of the inventive retention apparatus of the invention, in which the retention apparatus is located in a side of a base structure.

FIG. 10 depicts a perspective view of an embodiment of the inventive retention apparatus of the invention.

### DETAILED DESCRIPTION OF THE INVENTION

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

As used herein, “base structure” 100 includes within its meaning a physical structure, which may be, but is not necessarily planar, and that may comprise one or a plurality of layers of material, wherein each sheet of material comprising the base structure may be of the same material composition or differing material composition. “Traction pad” and “surface covering” are each non-limiting examples of a base structure. The material comprising the base structure may exhibit a desired durometer, surface friction, surface cushion, surface texture, appearance, sound absorbing characteristic, or a combination of such characteristics, such that the base structure provides a desired cushioning, traction, appearance, friction, sound absorbing, appearance or other desired characteristic when applied to a subject surface. The subject surface may be any surface such as, by way of example and not limitation, a boat, vehicle, kayak, recreational vehicle, camper, golf cart, wall, floor, pool or spa surface. The a base structure may be attached to the subject surface by any means including chemical bonding, gravity, snaps or retentive features in the a base structure material that are adapted to retain or capture the traction pad when used adjacent to other traction pads. Such features may include, for example, a friction fit between adjoining base structures or complementary retaining features in adjoining base structures. Traction pads may comprise any material that achieves the desired cushioning, traction, appearance or sound absorbing characteristics, for example and not by way of limitation, Ethylene-Vinyl Acetate (EVA) foam, Polyethylene (PE) foam, combinations of EVA and PE, rubber, plastics or any other material or combination of materials. Typically, but not necessarily, such materials are provided as stock in sheet form. A base structure of the invention may comprise one or a plurality of layers of traction pad sheet material. The layers of sheet material comprising a traction pad of the invention may be attached to one another by any means including, for example, chemical bonding, heat lamination or any other means known in the art for binding sheets of material together.

In the figures, like numbered item callouts refer to like features.

As used herein, “object(s) to be retained”, item 104, includes within its meaning any object desired to be retained in the base structure of the invention 100, and may include lighting elements, glow-in-the-dark elements, or any other desired element or structure to be retained, whether or not such object to be retained emits light. The object to be retained may be of any cross sectional shape.

As used herein, “lighting element” includes within its meaning any element or structure, whether or not powered by electricity, that emits light, and may include strips of electrical light elements such as Light Emitting Diodes (LEDs), lasers, incandescent lighting, and other electrically powered lighting. “Lighting element” also includes within its meaning glow-in-the-dark lighting elements and structures that utilize bioluminescence, chemiluminescence, phosphorescence, and radioluminescence to emit light. “Lighting element” also includes within its meaning structures that comprise optical fibers having a first end into which light energy is launched from a light source and wherein the launched light energy travels along the fiber and is partially internally reflected allowing a portion of the light energy launched into the fiber to escape the fiber along its length, causing the optical fiber to appear to glow. Any light source may be used to launch light energy into such optical fibers including, but not limited to, LEDs, lasers, laser diodes, incandescent light, and naturally occurring light. The lighting elements of the invention may emit light of any color or intensity, and may be controllable through the use of a controllable power source in communication with a light source, or lighting element, for controlling the amount of power supplied to the light source or light element, or color of the light element, and thereby allowing control of the amount, or color, or both, of light energy emitted by the lighting element. The controllable power source may be in communication with a controller, which may, for example comprise a switch array or software application executing non-transitory computer executable instruction on a computing device, such as a computer or cell phone, allowing a user to thusly control the color or intensity, or both, of the light emitted by the lighting element. Such control may be utilized, for example, to command a steady light of unchanging intensity, or color, or both. Alternatively, such control may be utilized to command time-varying changes in light intensity or color, or both, in either random or repetitive patterns. As a non-limiting example the invention may be utilized to create specific moods such as when a lighted traction pad, or plurality of traction pads, are attached to a surface or a plurality of surfaces of a boat such as floor surfaces, gunwales, console surfaces, or other surfaces when the boat is operated at night.

As used herein, “compressible” includes within its meaning, as a non-limiting range, a Shore hardness range of between 10 and 100 on the Shore 00 scale and any range within this range.

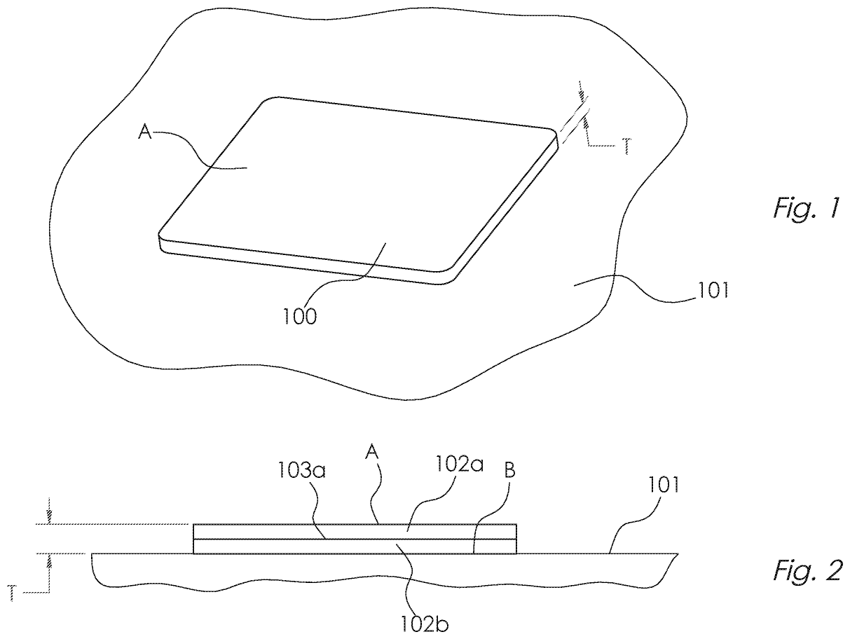

Referring now generally to FIGS. 1 through 10, various embodiments of the invention are depicted. In embodiments, the invention may comprise a retention apparatus 105 for retaining an object to be retained 104, which may be of any cross sectional shape, disposed in a base structure 100; an apparatus and method for capturing lighting or other elements in a traction pad; or the resulting traction pad with the included captured elements. In an embodiment, the invention comprises features that allow the incorporation of lighting elements into a traction pad or other base structure, and the embodiments shown are exemplary only. The base structure may be, but is not necessarily, planar. In the figures certain non-limiting embodiments are depicted in which the base structure 100 may be a planar structure such as a traction pad, and surface A may be the traction surface of a typical traction pad which may be comprised of at least one layer of EVA foam or other material. Again this is but a non-limiting example of a base structure. In a typical embodiment traction pad 100 may comprise a plurality of layers of sheet material, resulting in a total traction pad thickness of T. It is not necessary that the material comprising each layer of a multi-layer base structure be comprised of similar materials. Base structure 100 may be attached to a surface 101 which may be a surface of, for example, a boat deck, a recreational vehicle, a kayak, a pool or spa deck, a golf cart, or any other surface upon which it is desired to apply the base structure.

Referring now to FIG. 1, an exemplary base structure 100 is attached to a surface 101 as herein before described. The method of attachment of traction pad 100 onto surface 101 may be any method of attachment, including but not limited to the use of chemical adhesives or snaps. In the exemplary embodiment of FIG. 1, traction pad 100 may provide a decorative or cushioning effect to surface 101 upon which it is attached, and it may be of any arbitrary shape or outline. The shape and outline of traction pad 100 as depicted in FIG. 1 is merely exemplary. Surface A is shown for reference and may be, for example, an upper surface of a traction pad in the exemplary case in which base structure 100 is a traction pad. While base structure 100 is depicted as a planar shape in FIG. 1 having a thickness T, it is not necessary that this be the case. In general, base structure 100 may take on any planar or non-planar shape.

Referring now to FIG. 2, an exemplary base structure 100 comprising two layers of sheet material such as a compressible material including but not limited to EVA or PE foam, or rubber, or any compressible material, is depicted as attached to surface 101. Surface A may be an upper surface of the base structure which is the surface upon which, for example, a boater may stand in the cases in which the base structure is mounted onto the deck of a boat to function as a traction pad. Surface A may, in an embodiment, provide a decorative, cushioning or non-slip surface to the boat user. The base structure 100 may, in the non-limiting exemplary planar case shown, be of total thickness T and, in this exemplary embodiment, is comprised of sheet material layer 102a and sheet material layer 102B which have been attached at boundary 103a by any means known in the arts such as chemical adhesives or attachment methods using heat to bond sheets 102a and 102b at boundary junction 103a which may include, but not be limited to flame lamination or other known methods of applying heat. Surface B of base structure 100 which may be, but is not necessarily, the surface on which the base structure 100 is attached to surface 101.

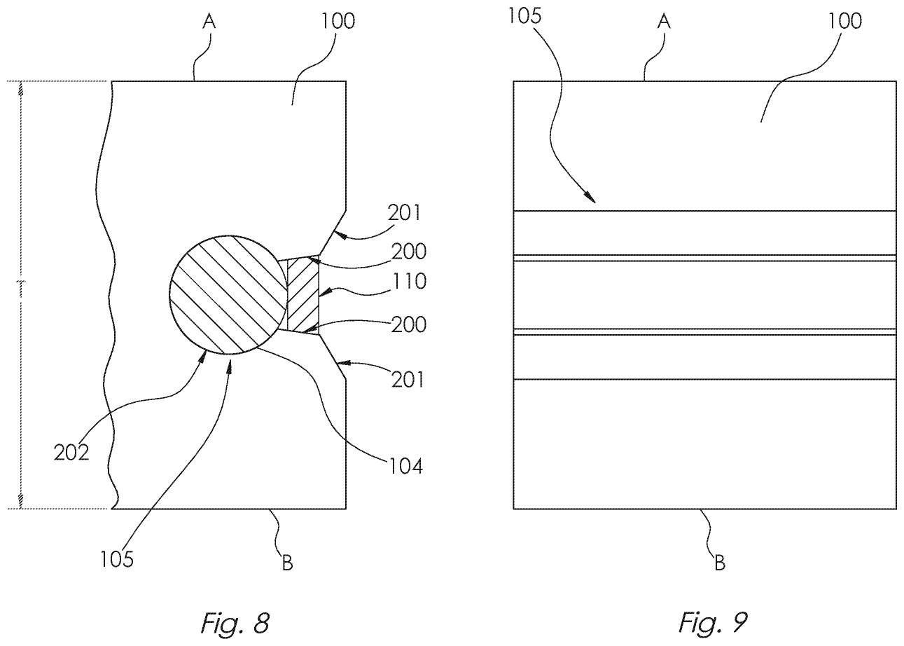

Referring now to FIG. 3, an embodiment of the invention is shown in which the objects to be retained 104 are captured and retained within a retention apparatus 105 which is shown in further detail in FIG. 8. In an exemplary non-limiting embodiment in which the object to be retained 104 is a lighting element and the base structure has a thickness T, light rays C may emanate from the sides of base structure 100, causing illumination, for example in the form of a soft glow effect, around exterior surfaces of the base structure 100. Lighting elements 104 may be inserted into the light retaining features of the light retaining groove where they may be held there by forces provided by the compression of the compressible base structure material, such as EVA or PE foam, or rubber, acting on lighting element 104 to retain it in place. Surfaces A and B are shown for reference.

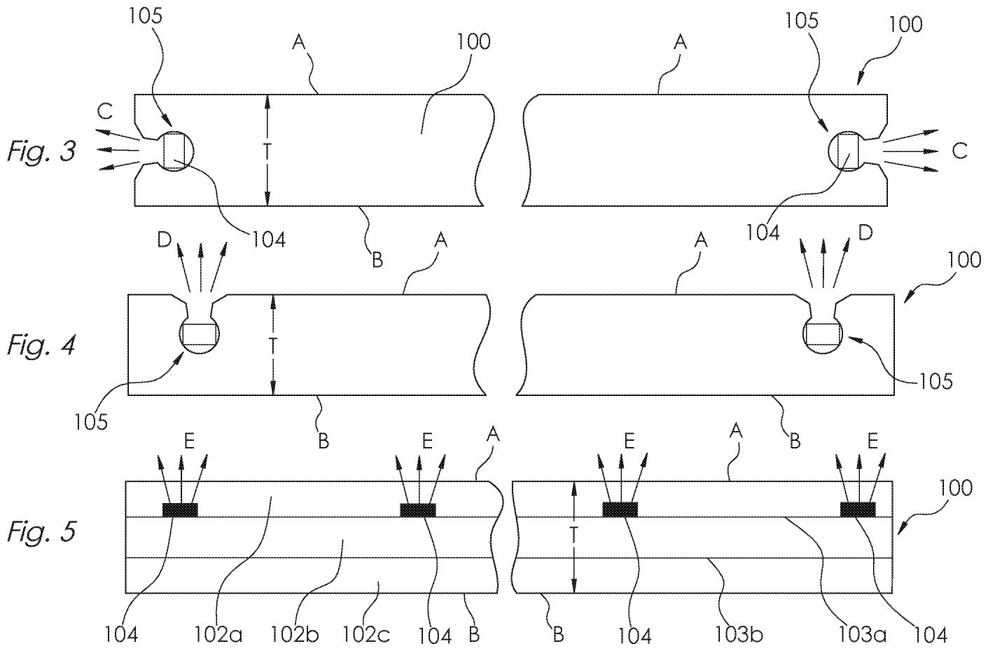

Likewise, FIG. 4 depicts an exemplary, non-limiting embodiment of the invention in which retention apparatus 105 is disposed in an upper surface, surface A, of base structure 100 of thickness T, allowing light D to emanate upward from surface A of base structure 100. In this example, lighting elements 104 may provide a lighted outline of the base structure 100. However, this is simply an exemplary use, and any pattern of lighting may be routed or otherwise formed in surface A of traction pad 100 to form any pattern desired, including but not limited to decorative patterns or lettering. Also depicted is surface B of base structure 100 which is may be, but is not necessarily, the surface on which the traction pad is attached to surface 101 as shown in FIGS. 1 and 2. Such attachment between surface B and surface 101 may be accomplished by any means know in the art such as, for example, chemical adhesives, snap fixtures, being held in place by gravity, or any other means.

Referring now to FIG. 5, an alternate embodiment of the invention is depicted in which the object to retained 104 is one more lighting elements 104 that are captured between layers in a multi-layer base structure 100, without the use of the retention apparatus 105, and in which base structure 100 has a thickness T. In the specific example shown in FIG. 5, an exemplary three layer (102a, 102b, 102c, having boundary junctions 103a and 103b) base structure is depicted; however, it is understood that the scope of the invention includes any number of layers of planar sheet material. It is not necessary that each layer of base structure 100 be of similar thickness. In the embodiment depicted in FIG. 5, lighting elements 104 are captured and retained between layer 102a and layer 102b in boundary junction 103a, allowing light E to radiate through layer 102a, causing a soft glow to be created anywhere the lighting elements 104 are located on the base structure 100. Lighting elements 104 may be bonded to a surface of one or both of layer 102a and layer 102b. The scope of the invention includes any number, formation, shape or outline of lighting elements 104 such that any desired lighted pattern can be created in base structure 100. Surface B is shown for reference and is typically the surface upon which base structure 100 may be attached to surface 101 as depicted in FIGS. 1 and 2.

Retention apparatus 105 may be located in any surface, and in more than one surface, of base structure 100. Thus, in an exemplary embodiment, retention apparatus 105 may be disposed in more than one surface of base structure 100, enabling retention apparatus 105 to wrap around base structure 100, and to retain any object desired to be retained 104, in any pattern. Further, in embodiments, base structure 100 may comprise more than one retention apparatus 105, on one or a plurality of base structure surfaces, in any pattern.

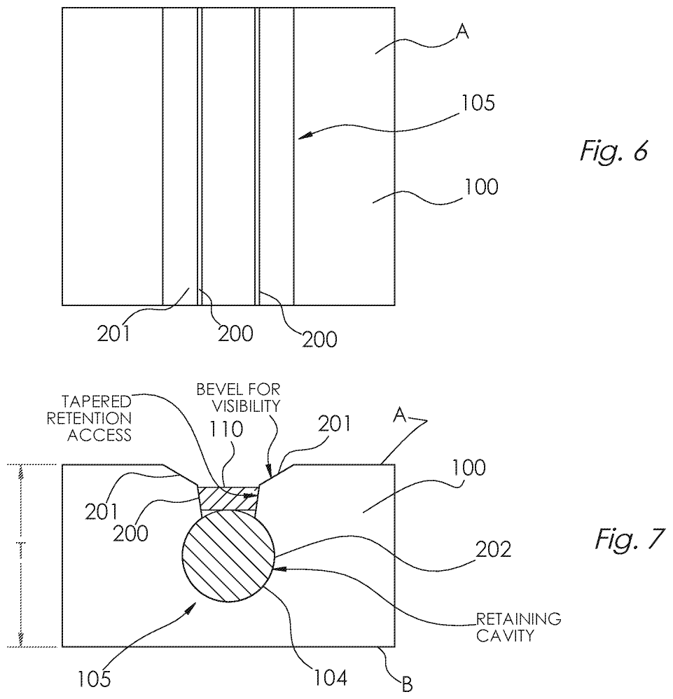

Referring now to FIGS. 6 and 7, an upper view and cross-section view of the retaining apparatus of an embodiment of the invention is depicted in which the retaining apparatus is disposed in a top surface of a base structure 100. The retaining apparatus may comprise opposing bevels for visibility 201, opposing tapered window retention surfaces 200, and retaining cavity 202, which features collectively comprise a retaining apparatus for retaining an object to be retained 104 (as depicted in other figures) in retaining cavity 202. These features may be routed into base structure 100. While retaining cavity 202 is shown to be circular in cross sectional shape in the example of FIG. 7, any cross sectional shape such as rectangular, triangular, circular or any other cross sectional shape, which is not necessarily symmetrical in shape, may comprise retaining cavity 202. Base structure 100 is characterized as having a surface which may be any surface of base structure 100. Retaining cavity 202 may be disposed in and running along and below the surface (in the example of FIG. 7, the surface is surface A, but generally, the surface is any surface of base structure A). The retaining cavity 202 has an opening into the surface of base structure 100 (in the example of FIG. 7, surface A) between opposing tapered window retaining surfaces 200, through which the object to be retained must pass in order to be inserted into retaining cavity 202. In FIGS. 7 and 8 it can been seen that, in embodiments, optional window 110 may occupy and occlude this opening. The opening between opposing tapered window retaining surfaces 200 runs along the retaining cavity for allowing the insertion of an object to be retained 104 in retaining cavity 202. The retaining cavity opening is further defined as comprising a pair of opposing bevel surfaces 201 where the retaining cavity opening opens into the base structure surface (surface A in the example of FIGS. 7 and 8). The retaining cavity opening has a pair of opposing window retention surfaces 200 disposed between the retaining cavity 202 and the pair of opposing bevel surfaces 201. In embodiments, the cross sectional shape of retaining cavity 202 may be complementary to the object to be retained 104. In embodiments, the object to be retained 104 may be larger in a cross sectional dimension such that when the object to be retained 104 is placed into retaining cavity 202, the material comprising traction pad 100 is compressed. The object to be retained 104 may be inserted into the retaining cavity 202 where it is held in place, typically, by the compression of base structure 100 material around the object to be retained 104, which base structure 100 material is, in embodiments but is not necessarily, compressible and may be but is not necessarily EVA or PE foam. In the embodiment depicted in FIGS. 6 and 7, the object to be retained 104 is shown in exemplary fashion as lighting element 104, which is held in place by retention forces created by the compression of the base structure material resulting in normal forces on object to be retained 104, holding it in place. In alternate embodiments, optional window 110 which may be a translucent or transparent material, such as lexan or any clear, semi-opaque, translucent or other material, such as a plastic material, may be captured between the opposing surfaces of tapered window retention surfaces 200, and may be held in place by compressive forces in the base structure 100 material exerting forces optional window 110, causing it to be held in place as depicted. In alternate embodiments, item 110 need not be clear or translucent, nor made of plastic necessarily. In this way, retaining cavity 202 may be sealed by optional window 110 to prevent the entrance of dirt, solvents, humid air or other gases, water or other contaminants into retaining cavity 202.

Referring now to FIGS. 8 and 9, a side view and cross-section view of the light retaining apparatus of an embodiment of the invention is depicted in which the object retaining apparatus is disposed along a side of a base structure 100 such as a traction pad. The retaining apparatus comprises opposing bevels for visibility 201, opposing tapered window retention surfaces 200, and retaining cavity 202 which features retaining apparatus 105 for retaining an object to be retained 104 in retaining cavity 202. These features may be routed into base structure 100. While retaining cavity 202 is shown to be generally circular in shape, any shape such as rectangular, triangular or any other shape in cross-section may comprise retaining cavity 202. The object to be retained 104 is inserted into retaining cavity 202 where it is held in place, typically, by the compression of the base structure 100 material, which may be but is not necessarily compressible material such as EVA or PE foam. In the embodiment depicted in FIGS. 8 and 9, the object to be retained 104 is lighting element 104, which is held in place by retention forces created by the compression of the base structure 100 material exerting normal forces on element 104, causing it to be retained in place. In alternate embodiments, optional window 110 which may be any transparent, semi-opaque, translucent or other material, such as a plastic or lexan material or any polycarbonate, may be captured between the opposing surfaces of tapered window retention surfaces 200, and held in place there by compressive forces in the base structure 100 material acting on optional window 110 and thereby holding it in place. In alternate embodiments, item 110 need not be clear or translucent, nor made of plastic necessarily. Item 110 may be fabricated from any material. In this way, retaining cavity 202 may be sealed to prevent the entrance of dirt, humid air, water or other contaminants. The selection of material comprising optional window 110 may be made based upon the desired amount of light transmission there through, a desired color to be achieved when viewing the light transmitted through window 110. The material comprising optional window 110 may be selected for chemical, fluid, temperature or other environmental compatibility for cases in which the invention may be used in environments in which the window may come into contact with specific chemicals or materials, or any other considerations specific to a particular use.

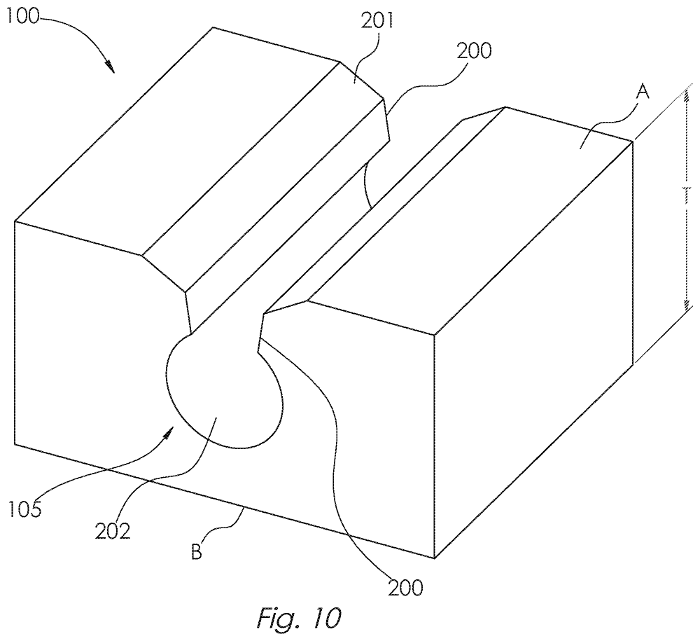

Referring now to FIG. 10, a perspective view of the light retaining cavity is shown in a traction pad of thickness T. In this figure, the object to be retained 104, which may be a cylindrical object, is not depicted so as to clearly show the retaining cavity 202, which in the exemplary embodiment shown is cylindrical but make take any cross sectional shape.

What is claimed is:

1. An retention apparatus for retaining an object, comprising:
a base structure having a surface; and
a retaining cavity disposed in and running along and below said surface, said retaining cavity comprising an opening into said surface that runs along said retaining cavity for allowing the insertion of an object to be retained in said retaining cavity;
wherein, in cross section, said retaining cavity opening is further defined as comprising a pair of opposing bevel surfaces where said retaining cavity opening opens into said base structure surface, and wherein said retaining cavity opening further comprises a pair of opposing window retention surfaces disposed between said retaining cavity and said pair of opposing bevel surfaces.

2. The retention apparatus of claim 1, in which said base structure is further defined as comprising a compressible material.

3. The retention apparatus of claim 2, in which said compressible material is further defined as being either EVA or PE foam.

4. The retention apparatus of claim 1, in which said base structure is further defined comprising a plurality of layers of sheet material.

5. The retention apparatus of claim 1, wherein said retaining cavity is comprised of a circular cross section.

6. The retention apparatus of claim 1, further comprising a lighting element disposed in said retaining cavity.

7. The retention apparatus of claim 1, further comprising a window disposed and retained between said opposing window retention surfaces.

8. The retention apparatus of claim 6, further comprising a window disposed and retained between said opposing window retention surfaces.

9. The retention apparatus of claim 7, wherein said window comprises transparent material.

10. The retention apparatus of claim 7, wherein said window comprises translucent material.

11. The retention apparatus of claim 6, wherein said lighting element is further defined as an optical fiber.

12. The retention apparatus of claim 6, wherein said lighting element is further defined as an LED strip light element.

13. The retention apparatus of claim 6, wherein said lighting element is further defined as comprising a phosphorescent material.

14. The retention apparatus of claim 8, wherein said lighting element is further defined as an optical fiber.

15. The retention apparatus of claim 8, wherein said lighting element is further defined as an LED strip light element.

16. The retention apparatus of claim 8, wherein said lighting element is further defined as comprising a phosphorescent material.

17. A lighting system for a base structure, comprising:
a base structure comprising a plurality of stacked planar sheets of material, wherein each sheet has an upper planar surface and a lower planar surface, and further comprising a top sheet having a lower planar surface that is laminated to an upper planar surface of the next planar sheet below said top sheet in said stack of sheets; and
a lighting element disposed between said top sheet and said next planar sheet below said top sheet in said stack of sheets oriented such that a portion of the light emitted by said lighting element passes through said top sheet.

18. The lighting system of claim 17, wherein said lighting element is disposed in a groove in said upper surface of said next planar sheet below said top sheet in said stack of sheets.

19. The lighting system of claim 35, wherein said lighting element is disposed in a groove in said lower surface of said next planar sheet below said top sheet in said stack of sheets.

20. The lighting system of claim 35, wherein said plurality of stacked planar sheets are laminated by chemical bonding.
